(19) United States
(12) Patent Application Publication
(10) Pub. No.: US 2013/0183893 A1
(43) Pub. Date: Jul. 18, 2013

(54) Extractor Apparatus

(71) Applicant: Ulrich Gartner, Grafenberg (DE)

(72) Inventor: Ulrich Gartner, Grafenberg (DE)

(73) Assignee: WALDNER LABOREINRICHTUNGEN GMBH & CO. KG, Wangen (DE)

(21) Appl. No.: 13/824,845

(22) PCT Filed: Nov. 11, 2011
(86) PCT No.: PCT/EP2011/005689

§ 371 Date: Mar. 18, 2013

(30) Foreign Application Priority Data
Nov. 13, 2010 (DE) 10 2010 051 364.4
May 26, 2011 (DE) 20 2011 101 114.7

(51) Int. Cl. B08B 15/02

(52) U.S. Cl. CPC B08B 15/023
USPC 454/66; 361/225

(57) ABSTRACT

The invention relates to an extractor apparatus (10), in particular a laboratory extractor apparatus, with a working area (13) and with a fan arrangement (26) for generating an air flow (27) or an inlet opening for an air flow (27) for the removal of gases and/or particles from the working area (13) and with at least one surface bordering the working area (13). The extractor apparatus (10) has charging means (30) for ionising the air flow (27) and/or for electrostatic charging of at least one surface.

The invention relates to an extractor apparatus, in particular a laboratory extractor apparatus, with a working area and with a fan arrangement for generating an air flow or an inlet opening for the removal of gases and/or particles from the working area and with at least one surface bordering the working area.

An extractor apparatus of this type, used for example in laboratories, is known for example from DE 201 06 395 U1. The extractor apparatus has a working chamber which may be closed at the front by a door. To remove for example gases from the working chamber and from the working area respectively, ventilation is provided, which requires a fan arrangement. However, in the processing and use of powdery, pure active substances, in their production, in the case of fine dusts or also the handling of aerosols, there is the problem that pure venting and the creation of an air flow may not be sufficient to ensure a reliable removal of the gases and/or particles from the working area. This may result in pollution of the environment of the extractor apparatus, but especially to a hazard to persons using the extractor apparatus, e.g. as a laboratory workstation.

The problem of the invention is therefore to provide an improved extractor apparatus, in particular a laboratory extractor apparatus.

To solve the problem it is provided for an extractor apparatus of the type described above, that it has charging means for ionising the air flow and/or for electrostatic charging of at least one surface.

A basic concept of the invention is, with the aid of the charging means, to influence the electrical properties of the extractor apparatus and/or the air flow in such a way that in particular particles are conveyed especially well away from the working area. This reduces the risk of a user of the extractor apparatus suffering injury to health. An especially preferred field of use is the production, testing and study of pure active substances, in particular powdery active substances. Toxic fine dusts may also be optimally bound and transported away using the method according to the invention. The invention is especially advantageous when used for aerosols.

It lies within the scope of the invention on the one hand to ionise the air flow, and on the other hand to charge electrostatically one or more surfaces, while the combination of both measures is especially advantageous. Naturally, not only electrostatically chargeable surfaces may be present, but also surfaces which are not electrostatically chargeable. It is also possible, in connection with an extractor apparatus according to the invention, to provide only ionisation of the air flow, while no influencing of surfaces through electrostatic measures is effected. This means that an extractor apparatus which is essentially electrostatically neutral or at least has no defined electrostatic charging requirement, may be vented optimally with the aid of the air flow ionised according to the invention.

The electrostatically chargeable surface includes for example a side wall surface, a bottom surface provided for the placing of objects or also an inner surface or outer surface of a support element.

Preferably zoning is provided on the one or more electrostatically chargeable surfaces, i.e. the surface has two zones, electrically insulated from one another, chargeable by the charging means with different electrical polarity. Additional zones, electrically insulated and electrostatically chargeable separately from one another, may also be provided.

To make the surfaces electrostatically chargeable, it may be provided for example that they are made of metal or have an electrically conductive coating.

The zone or zones comprise(s) for example a working zone and a boundary zone, in particular annular or partly annular, bounding the working zone at the side. For example the working zone is located in the centre of the working area and surrounded by the annular boundary zone. The working zone and the boundary zone are electrostatically chargeable, but with differing electrical polarity.

Also preferred is guidance or control of the air flow: the extractor apparatus expediently has air guidance means to direct the air flow or part of the air flow along the surface or surfaces. This surface or surfaces involve for example a side wall surface or a bottom of, in particular the working surface of the working area.

In particular in this connection it is advantageous when the charging means ionise the air flow, for example electrically charge it, electrically discharge it or, especially preferred, neutralise it, with this electrically conditioned air flow being guided or flowing along at least one surface, for example the bottom surface and/or a side wall surface of the working area, in particular a working chamber, in order to condition this particular surface, for example to neutralise it. Neutralisation is effected in particular by ionisation which is neutral on average over time, e.g. alternately +6 kV and −6 kV.

Expediently provided for this purpose are air guidance means or air directing means, for example guide surfaces and/or aligned air outlets, from which the electrical conditioned air flow departs and flows along the relevant surface.

An ionised, in particular electrically neutral air flow which flows along the surface also has the advantage that it not only sets the surface electrically so that no particles or at least only a few particles adhere to it, but also that at the same time the particles concerned are carried away from the surface.

At this point it may be noted that no special requirements are made for the design and material of the wall surface, even if e.g. an electrically conductive surface is preferred. It is sufficient if the ionised air flow, in particular electrically neutral in the middle, flows along the surface, for example along a plastic surface or similar, in order to provide it with ideal electrical setting. In any case particles do not adhere, or only to an insignificant extent, to the surface which is not electrically charged, or not specifically, or neutralised.

It is also not necessary for the wall surface to be connected to an electrical potential, for example neutralised. Consequently it is possible for the air flow to neutralise or charge or discharge to a predetermined potential even an electrically non-conductive material, for example a plastic surface. Of course it would also be possible to condition the surface electrically not only by means of the ionised, for example neutralised, air flow, but also by means of an additionally applied electric potential.

It is sufficient if parts of the air flow are ionised or electrically neutralised through ionisation. It is also possible for different air flows to flow through the working chamber or working area or to flow along the relevant wall surfaces, wherein e.g. at least one first air flow is ionised while at least one other second air flow is not ionised.

It is also expedient, precisely in this connection, if such an air flow running along a wall surface or surface is ionised for the purposes of the invention, for example neutralised, while at least one other air flow, flowing for example through the centre of the working area or a working chamber remains electrically untreated. This central air flow is in particular also able to convey particles away from the inner zone of the working area or working chamber.

The working area is expediently bounded by one or more walls. Preferably the extractor apparatus has a working chamber which includes or bounds the working area.

The working chamber is expediently accessible through an access opening, which may be closed or secured by means of several measures which may be used separately or in combination. For example the working chamber may be closed by a door, which may also be described as a “window”. This door involves e.g. a hinged door, but expediently also a sliding door. A multi-section door, a folding door or similar is also possible. Naturally it is also possible to provide several doors to close the access opening.

It is also expedient to provide at the access opening one or more air curtains which protect the operator. It is also possible to provide advantageously at the door air guidance measures such that, on opening the door, an additional air flow occurs in the direction of the interior of the working chamber. Particles or gases are therefore carried away from the access opening, i.e. also away from an operator, so that the latter is protected.

It is preferable if the working area can be vented via one or more vent holes. Expediently provided at each vent hole is a filter with which the particles, gas constituents or the like may be filtered out. The air flow is able to flow from or out of the working area in the direction of the vent hole and can be carried through the latter away from the extractor apparatus. Preferably the extractor apparatus has an exhaust air connection which may be connected for example to an exhaust air duct system.

It is certainly possible to fit the ionisation device on the spot, i.e. for example directly at an air flow outlet which opens out in the working area, in particular the working chamber. Consequently the air or the air flow will be ionised on the spot, i.e. directly before the exit into the working area. However it is preferred to locate the ionisation device, or the charging means which include an ionisation device, at an air flow outlet of the fan arrangement. The air blown out by the fan will therefore be ionised before it is fed into a distributor system or a ducting arrangement. Consequently central ionisation is provided, which is cost-effective. The charging means, in particular the ionisation device, are expediently designed to ionise the air flow with varying polarity. For example the ionisation device changes the polarity at time intervals. It is therefore possible for e.g. particle accumulations on a surface, e.g. the working area, a side wall or similar, to be prevented or also removed.

It is especially preferred if the ionisation is effected so that the electrical charge is “zero” on a spatial and/or time average, i.e. for example the charging means charge or act upon the surfaces of the extractor apparatus in terms of location and/or time with changing polarity, so that they are electrically neutral averaged over location and/or time. This measure is also expedient for the ionisation or charging of the air flow or parts of the air flow, i.e. also the air flow or air flow portions are electrically neutral averaged over time, since for example parts of the air flow are charged or ionised by the charging means with alternating electrical polarity, and/or are charged or ionised by the charging means with differing polarity alongside one another. It is thus possible e.g. for spatially adjacent electrically positive charged and electrically negative charged air flows to mix with one another, so that altogether an electrically neutral air flow is formed.

Of course it is possible for an ionised and a non-ionised air flow and/or air flows ionised with different polarity to mix with one another, for example if the extractor apparatus has corresponding discharge openings arranged next to one another, from which the different air flows exit and are thus able to mix with one another.

Naturally the extractor apparatus may be operated in an advantageous variant of the invention both with ionised air and without ionised air, i.e. conventionally. For example, for this purpose, it is necessary only to switch the ionisation device off or on.

For distribution of the air flow and/or to take up the air flow from the working area, a ducting arrangement is expediently provided. Naturally, separate ducting arrangements may be provided for distribution of the air flow on to the working area and for taking up the air flow from the working area.

Preferably the ducting arrangement includes air guidance profiles and/or support elements, e.g. support profiles, a housing encompassing the working area or a door for sealing the working area (or both). The air guidance profiles and/or support elements include air guidance ducts and/or exhaust holes for the air flow. For example the air guidance profiles or support elements are guide profiles or corner profiles or edge profiles of a door or side wall. It is therefore possible for example to generate an air jet also in the area of a door, e.g. at its bottom edge.

The air guidance profiles are expediently so arranged that they guide or let out the air flow, in particular the ionised or neutralised air flow, so that it flows along the surface or surfaces, for example the bottom of the working area and/or a side wall.

Naturally, several ducts are provided expediently in the area of an access opening, to generate an air flow into the interior of the extractor apparatus.

The air guidance profiles and support elements are for example connected to one another so as to be electrically conductive. Consequently, electrostatic charging may be passed on from one air guidance profile and/or support element to the other support element and/or air guidance profile. It is also expedient that the support elements and/or air guidance profiles are so linked to one another that their air guidance ducts communicate with one another, i.e. that air from one air guidance profile or support element is able to flow into the other air guidance profile or support element over the connection point. Plug-type connections are preferred.

It is also expedient if two or more air flow outlets are provided, with non-ionised air flowing through one air flow outlet, while ionised air is able to flow through another air flow outlet. Of course it is also possible for air with a different electrical charge or ionisation to flow through different air flow outlets. Accordingly it is conceivable that an air flow is generated by one and the same fan arrangement, but is divided into a first and a second air flow, wherein the first air flow is ionised by the ionisation device or charging means, while the other air flow remains non-ionised. It is also possible for several fans to be provided, with each fan generating a different air flow, for example air flows of which one air flow is or will be positively ionised and another is or will be negatively ionised.

Preferred is a modular concept, i.e. one in which the extractor apparatus, for example its housing, air guidance element(s), air guidance profile(s) or similar, have a module seating, e.g. a plug socket or a shaft, in which a charging module with charging means for ionising the air flow or an air flow and/or for ionising a wall surface may be inserted. In this way it is possible for example to retrofit an existing conventional extractor apparatus, but one which has at least one module seating, with a charging module for ionising, for example neutralising, an air flow and/or a wall surface. Preferably the module seating is located on an air outlet of the housing.

The charging module has expediently an air inlet for the not yet ionised air flow. The charging module may also have a fan to generate the air flow onboard. Preferably provided on the charging module is an air outlet for the ionised, e.g. neutralised air flow. The charging module may also have electrical contacts for electrical connection with at least one wall and/or surface.

The charging means include expediently at least one ionising body to ionise the air flow. Expediently several ionisation bodies are provided. It is advantageous for several ionising bodies to be connected to a common electrical conductor for charging with the same electrical polarity. On the other hand it is also advantageous to provide at least 2 ionising bodies electrically insulated from one another, so that a first air flow portion may be ionised for example positively, while a second air flow portion is ionised negatively.

Each ionising body is located expediently at an air duct, for example the aforementioned ducting arrangement of an air guidance profile, a door or the like. It is preferred that one or more ionising bodies be provided for example on an air flow passage of an air guidance profile or duct or also on an air flow outlet of an air guidance profile or duct.

It is preferred that the ionising body or bodies form(s) or include(s) an air guidance surface for the air flow. By means of the air guidance surface for example the direction of the air flow is varied by a predetermined angle, i.e. a change is made for example to the direction of the air flow.

The ionising body or bodies may however also form or include for example a restrictor. It is also possible for the ionising body or bodies to be formed by or to include a discharge nozzle.

The ionising body or bodies expediently include(s) at least one grid. Such a grid is provided for example at a discharge opening of the air guidance profile or of an air guidance profile of the extractor apparatus. Of course it would also be possible to provide at this point for example just an arrangement of individual wires, in particular wires running at right-angles to the flow direction.

In a preferred variant the ionising body includes for example an air guidance surface. In another variant it is provided for the ionising body to include a needle point or a needle point profile.

Expediently the ionising body or bodies is or are wave-shaped at right-angles to the flow direction of the air flow. A wave form may be an even, for example sinusoidal, wave form. Also possible however is a zig-zag configuration, i.e. the wave troughs run to a point.

It has been found to be advantageous for the ionising body or bodies to taper in the outflow direction of the air flow. i.e. on the downstream side. Preferably the ionising body comes to a point on the downstream side or is in the form of a needle.

As mentioned above it is advantageous to provide several ionising bodies. Here it is preferred that at least 2, preferably more, ionising bodies are arranged next to one another in a row. This row arrangement runs for example at right-angles to the flow direction of the air flow which is to be ionised by the ionising bodies.

Here it is possible for the ionising bodies to have the same polarity, i.e. they charge the air flow with the same electrical polarity. Preferred, however are ionising bodies insulated from one another, adjacent to one another in the row direction, i.e. at least two ionising bodies insulated from one another, adjacent in the row direction. It is therefore possible that for example the two ionising bodies (or more ionising bodies) ionise the respective air flow passing through them in different ways, for example with different charging power and/or with differing polarity.

It is also possible for ionising bodies charged with opposite or different electrical polarity to be mounted alternately next to one another, so that for example an electrically positively charged ionising body is located between two electrically negatively charged ionising bodies. Naturally, the polarity and/or level of voltage of the respective ionising bodies may be changed over time.

It is also expedient for the extractor apparatus to have a controller to set an operating mode, for example of the fan arrangement and/or the charging means. The controller sets the operating mode for example on a time basis.

It is possible for the controller to switch between a cleaning mode and a working mode. In cleaning mode, for example, an enhanced air flow volume is used, to make possible an optimal removal of gases and particles from the working area. At the same time it is for example possible that the air flow through the working area is stronger in cleaning mode than in working mode. In working mode it may occur that the operator inadvertently directs the air flow towards himself, i.e. on to his body, so that he as it were contaminates himself with particles. It is therefore expedient to operate with a less strong air flow in working mode than in cleaning mode.

It is also possible that in working mode, one or more surfaces of the extractor apparatus are electrostatically charged to the effect that particles are attracted to the surfaces. Here it is preferable that the fan arrangement in working mode does not operate or operates with reduced power, which facilitates adherence of particles to the electrostatically charged surface. Then, in particular with closed access doors, a switch to cleaning mode is made, in which for example the electrostatic charging of the surface is made with the same polarity as the ionisation of the air flow, so that the particles are detached and carried away by the air flow, for example in the direction of the vent hole.

From the above example it is clear that it is expedient for the controller to interrogate one or more sensors of the extractor apparatus. If for example a sensor detects a position of a door at the access opening of the extractor apparatus, then the controller can set the relevant operating mode of the fan arrangement and/or the charging means depending on the position of the doors (open or closed, partly open, etc.).

Embodiments of the invention are explained below with the aid of the drawing, which shows in:

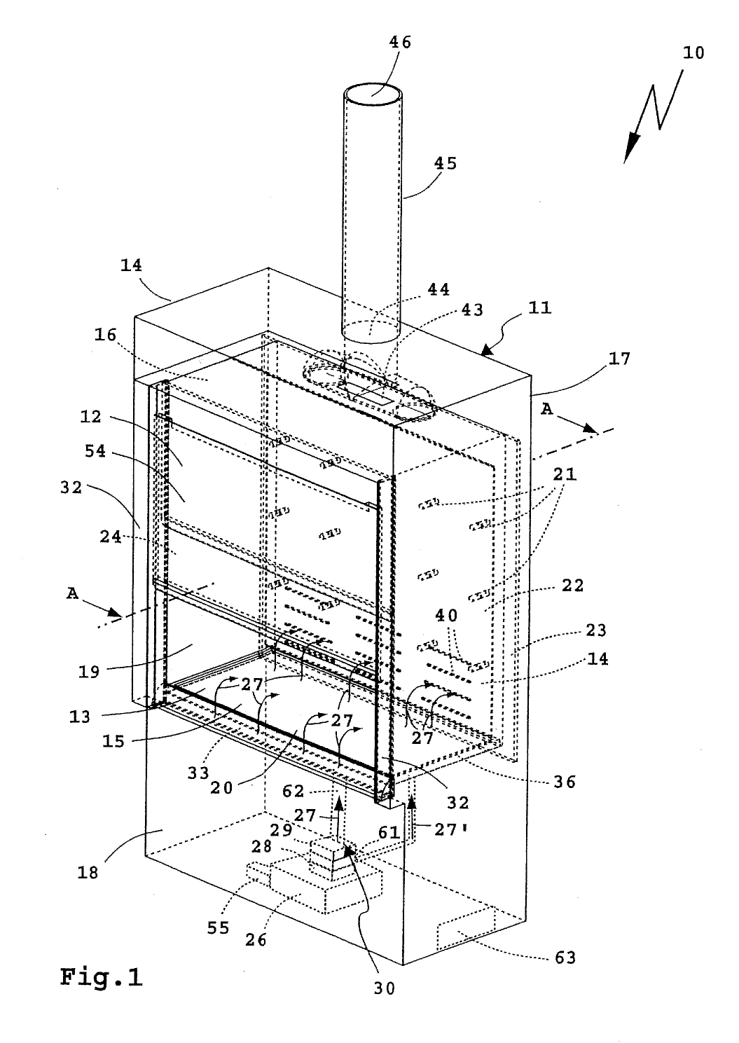

FIG. 1 a perspective oblique view of an extractor apparatus according to the invention, which in

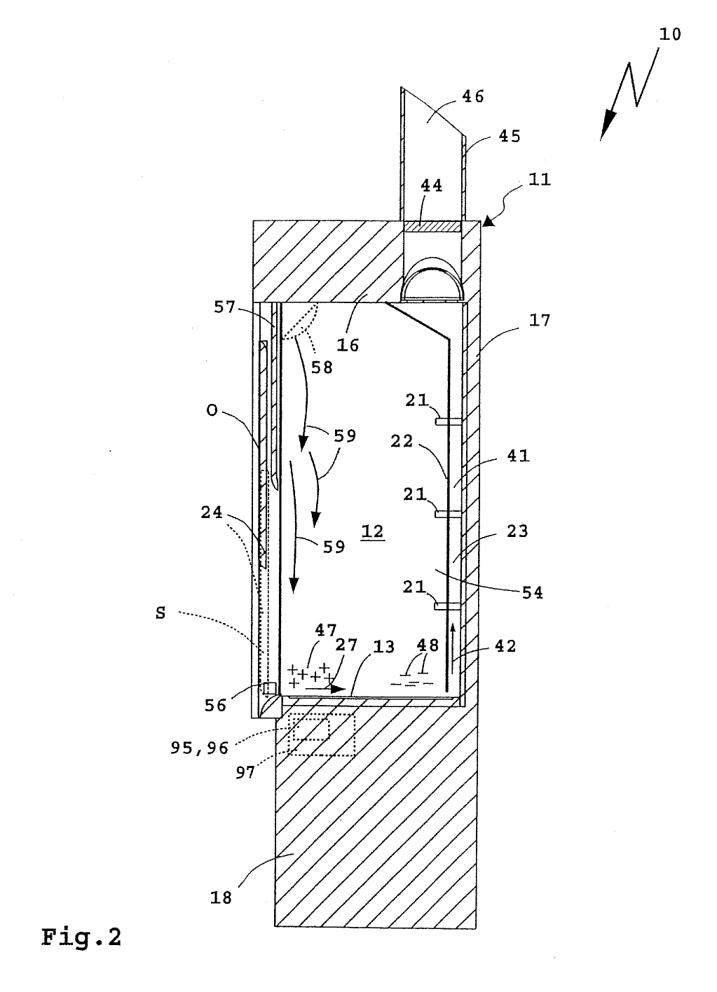

FIG. 2 is shown in section (section line A-A in FIG. 1)

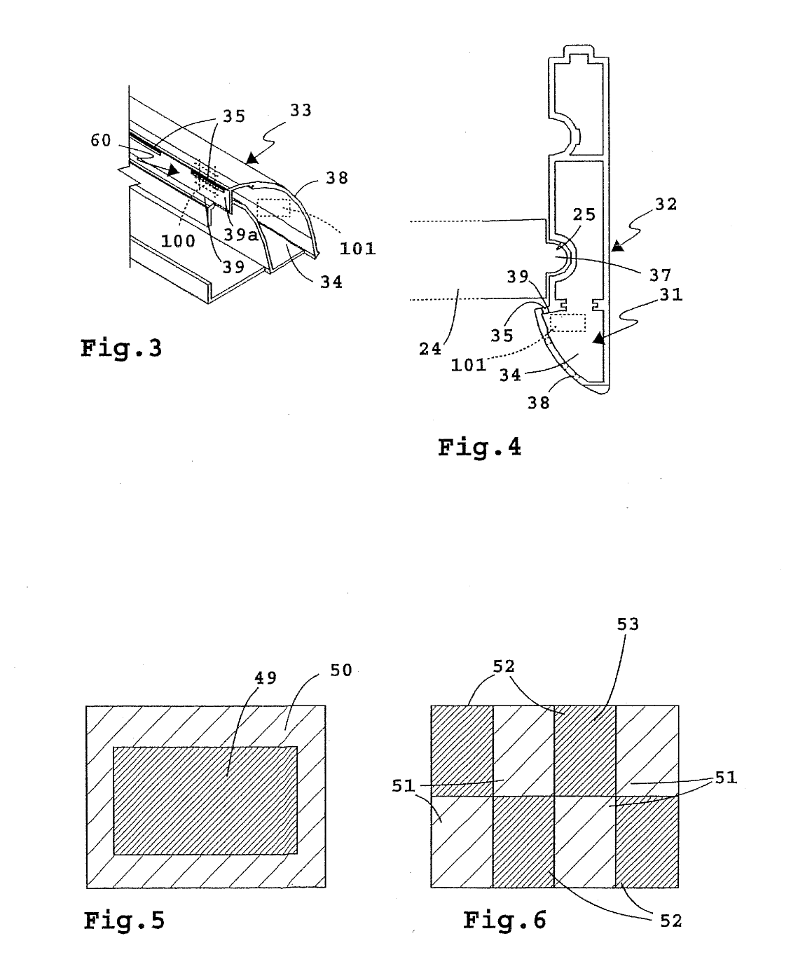

FIG. 3 a first air guidance profile of the extractor apparatus according to FIGS. 1, 2 in a perspective oblique view

FIG. 4 an end face view of a second air guidance profile of the extractor apparatus

FIG. 5 a schematic view of a first variant of a working area of the extractor apparatus according to FIGS. 1, 2

FIG. 6 a schematic view of a second variant of a working area of the extractor apparatus according to FIGS. 1, 2

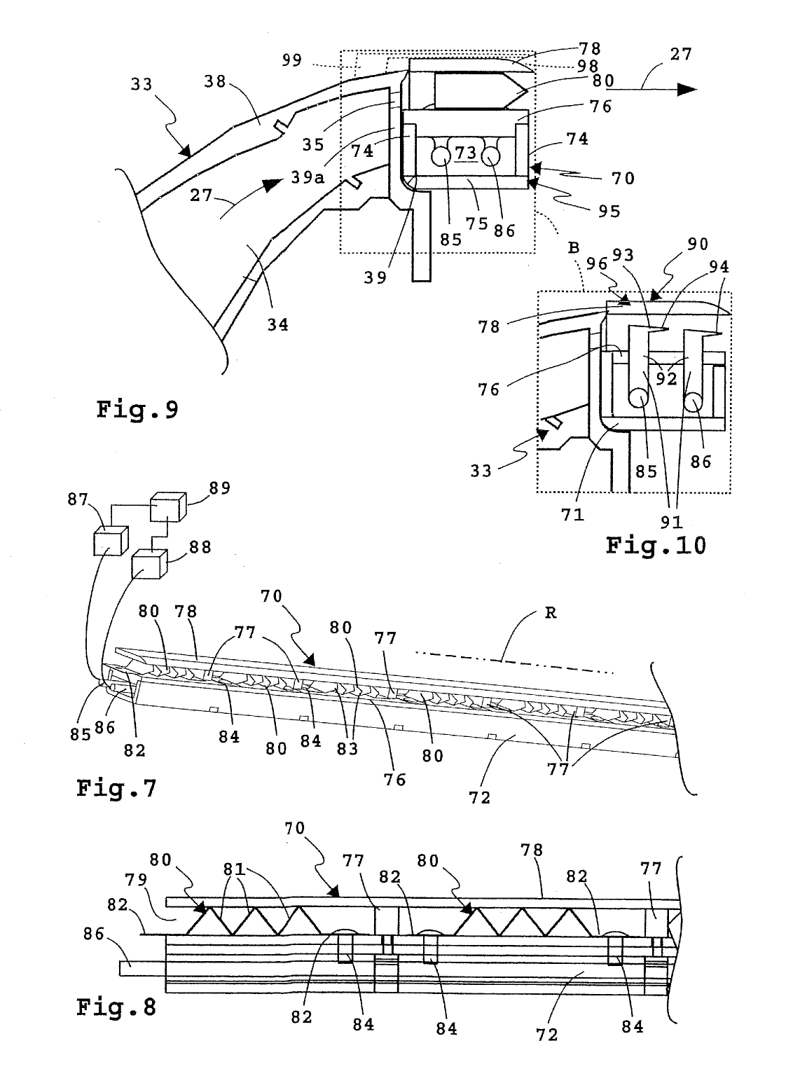

FIG. 7 an ionisation device for an air guidance profile in a perspective oblique view

FIG. 8 the ionisation device according to FIG. 7 seen from the front

FIG. 9 the ionisation device according to FIGS. 7, 8 mounted on an air guidance profile corresponding roughly to the air guidance profile of FIG. 3, from the side, and

FIG. 10 a further ionisation device, mounted on the air guidance profile according to FIG. 9, showing only a detail corresponding roughly to detail B in FIG. 9.

An extractor apparatus 10 is designed as a so-called laboratory extractor apparatus, laboratory extractor for short. While the extractor apparatus 10 shown in the drawing is intended for stationary use, it could also be used as a mobile extractor apparatus for example by attaching rollers to its underside. The extractor apparatus 10 includes a housing 11 which has a working chamber 12 in its interior. The working chamber 12 bounds a working area 13 which is at the disposal of an operator for example for research, processing or production of pure active substances, powdery active substances, fine dusts, in particular toxic fine dusts or also quite generally aerosols. The working chamber 12 is bounded at the side by side walls 14, at the bottom by a bottom panel 15, at the top by a top panel 16 and at the rear by a back panel 17.

A supporting structure or base 18, on which as explained rollers could be fitted, forms an underside of the extractor apparatus 10. The base 18 may for example be a solid base or may also have receiving spaces, in particular receiving spaces, drawers, etc. which may be closed by flaps.

The working chamber 12 is accessible from the front through an access opening 19, so that an operator may reach into the working chamber 12 with his arms or hands. In this way he may for example place objects, e.g. vessels in which powdery active substances or the like are contained, on a top side of the bottom panel 15, namely a bottom surface 20. In addition, holders 21 to which objects may be attached, are fitted to the back panel 17. The holders 21 are for example in the form of stands, projecting hooks or the like, which is not of importance here. The holders 21 penetrate a shielding panel 22 mounted in front of and substantially shielding the back panel 17. Between the shielding panel 22 and the back panel 17 is an intermediate space 23 which is used to ventilate the working chamber 12. The holders 21 therefore project forwards from the back panel 17 towards the working chamber 12 and penetrate the shielding panel 22, in front of which they also protrude. At the same time the holders 21 serve as supports or mountings for the shielding panel 22.

The access opening 19 may be closed by means of a door 24. The door 24 could of course also be described as a window. At any rate the door is a closing device for sealing the access opening 19. The door 24 is designed as a sliding door and may be moved between an upper open position O which substantially makes free the access opening 19, and a lower open position O in which the door 24 closes the access opening 19 with a seal which is at least substantially airtight.

The door 24 has a plate-like shape and can be moved on lateral guides 25 between the open position O and the closed position S, i.e. an upper and a lower position. In this connection it should be emphasised that of course an extractor apparatus according to the invention may also have a hinged door, a segmented sliding door or other similar doors or windows. There is also no problem in providing several doors. Nevertheless the operator is also effectively protected from harmful effects of, in particular, powdery substances, for example pharmaceutical substances, toxic fine dusts or similar to be found in the interior of the extractor apparatus 10, i.e. in the working chamber 12, even if the door 24 adopts its open position O or at least a partly open position.

With the aid of a fan arrangement 26, accommodated for example in the base 18, it is possible to generate an air flow 27 to carry gases and/or particles out of the working area 13.

Instead of or to assist the fan arrangement 26 it would also be possible to provide an external fan arrangement, to create e.g. an air flow coming in through an inlet opening 63.

The fan arrangement 26 is shown only in schematic form. For example the air flow 27 flows out of the fan arrangement 26 via an air flow outlet 28. Provided at the air flow outlet 28 is an ionisation device 29 which may be used to charge the air flow 27 electrically, i.e. to ionise it. The ionisation device 29 forms an integral part of charging means 30, which are used for electrostatic charging of the air flow 27.

The air flow 27 is distributed in the extractor apparatus 10, for which purpose a ducting arrangement 31 is provided. The ducting arrangement 31 includes for example air guidance profiles 32, 33, inside which are provided air guidance ducts 34. The air guidance ducts 34 have fluidic connection, e.g. via a line 62, with an outlet of the ionisation device 29, from which the the ionised air flow 27 exits, so that the air flow 27, which is ionised with the ionisation device 29 switched on, but is otherwise non-ionised, flows through the air guidance profiles 32, 33.

Expediently provided along the air guidance ducts 34 are air flow outlets 35, so that the air flow 27 is able to flow through the air flow outlets 35 and into the working chamber 12. Of course it is advantageous if outlets for the air flow 27 are also provided at other points, e.g. air flow outlets 36 on the outer peripheral area of the bottom panel 15 or the bottom surface 20.

The air guidance profiles 32 are located on the side walls 14 to the side of the access opening 19. At the same time the air guidance profiles 32 provide the guides 25, i.e. they have for example a guide slot into each of which a guide projection 37 of the door 24 engages. The guides 25 are for example longitudinal slots. The air guidance profile 33 extends downwards in the transverse direction at the access opening 19. The air guidance profiles 32, 33 are for example connected together in such a way, e.g. plugged into one another or fastened together at the edges, that their air guidance ducts 34 make an internal fluidic connection so that the air flow 27 can pass through them.

The air guidance profiles 32, 33 act in the manner of spoilers and have air guidance surfaces 38 which are curved. When the air guidance profiles 32, 33 are fitted to the extractor apparatus 10, the air guidance surfaces 38 act in the manner of funnels. On the side facing the working chamber 12, the air guidance surfaces 38 change into a step 39, above which air flow outlets 35 are again provided. The steps 39 therefore have a wall 39a facing the interior or the working chamber 12, on which the air flow outlets 35 are arranged so that air of the air flow 27 flowing out of them flows towards the working chamber 12. This has an advantageous effect, in particular when the door 24 is opened. A draught effect then occurs so that outside air is also carried towards the working chamber 12 from the air flowing out of the air flow outlets 35 towards the interior of the extractor apparatus 10, i.e. the working chamber 12.

Here, provision is made for optimal venting: exhaust air is able for example to flow through discharge openings 40 on the shielding panel 22 in the direction of the intermediate space 23 which in this respect forms a discharge duct 41, even if it has a large flat extent or flat shape. The air flow 27, where applicable ambient air flowing through the access opening 19 into the working chamber 12, also enters the discharge duct 41 through the discharge openings 40, to form an exhaust air flow 42.

The exhaust air flow 42 flows upwards in the intermediate space 23 towards a vent hole 43 provided in the top panel 16. Below the vent hole 43, the intermediate space 23 is expanded due to the shielding panel 22 having a section running forwards at an angle towards the access opening 19.

A filter 44 may be provided for example at the vent hole 43, so that the exhaust air flow 42 may be filtered.

Also provided at the top panel 16 is a tube 45, which makes a fluidic connection with the vent hole 43 so that the exhaust air flowing through the vent hole 43 may flow through the tube 45, consequently an exhaust air duct 46, away from the extractor apparatus 10. For example the tube 45 is provided for connection to a venting system or an exhaust air duct, to which other extractor apparatus units, not shown in the drawing, may be connected. With regard to the vent hole 43 it should be added that it is located in a rear section of the working chamber 12, close to the top panel 16.

Naturally it is also possible to provide further vent holes or discharge openings communicating with the vent hole 43, from which exhaust air is able to flow out of the working chamber 12 towards the vent hole 43.

Now the arrangement can be made so that the ionisation device 29 ionises the air flow 27 continuously, for example with a continuous positive electrical charge or a continuous negative electrical charge, as indicated by air particles 47 designated “plus” in FIG. 2. Negatively charged particles 48 (also shown schematically), e.g. a powder, are therefore attracted and carried away by the air flow 27, which has a positive electrical charge, so that the particles 48 are removed from the working area 13 in an optimal manner. Any risk to the operator is therefore minimal. In FIG. 2 the air particles 47 are shown separately from the particles 48, but may or will become mixed together in practice.

It is also possible for the air flow 27 to be given a negative and a positive electrical charge, e.g. by means of ionisation alternating in space and/or time, so that on average it is electrically neutral. This may also be the case for the particles, so that the latter are electrically neutral and do not adhere to the inner walls of the working chamber 12 but are carried away by the air flow 27. This effect may be further enhanced for example by electrostatic charging by the charging means 30 of a working zone 49 and a boundary zone 50 surrounding the working area 13, advantageously with different polarity. The working zone 49 and the boundary zone 50 (FIG. 5) are for example areas of the bottom surface 20 electrically insulated from one another and which may undergo differing electrical charging. If therefore for example the air particles 47 i.e. the air flow 27 is positively charged, then expediently the boundary zone 50 is also positively charged, so that no particles 48, in this case electrically positively charged, are able to adhere there. The positive electrical charging of the particles 48, e.g. of the powder, takes place in the central zone of the working area 13, i.e. in the working zone 49, which preferably is also given a positive electrical charge. If the particles 48 are held for example in containers which are electrically conductive and in electrical contact with the working zone 49, then by this means the particles 48 in the respective container placed there are also positively charged.

It goes without saying that other zonings of a particular electrostatically chargeable surface of an extractor apparatus according to the invention are possible, e.g. the matrix-like zoning of the surface 53 according to FIG. 6. Here for example negative zones 51 and positive zones 52 are arranged in the manner of a chessboard. Of course a strip-like arrangement, an arrangement with annular zones, in particular concentric, of different electrical polarity, or the like, are for example also easily possible.

In a preferred variant, the surface 53 is electrically neutral on average over space and/or time. For example the charging of positive zones 52 and negative zones 51 balances out in such a way that on average over space, charging is zero. This is however not absolutely essential, but just an option.

It is also possible for the charging means 30 to provide an electrostatic charge to other surfaces of the extractor apparatus 10, in order to facilitate optimal removal of particles or other substances from the working chamber 12. So it is possible for example that air guidance profiles 32, 33 as a whole but in particular the air guidance ducts 34 may be made electrically conductive, i.e. charged electrostatically. The air guidance profiles 32, 33 may for example be made of metal, in particular aluminium. It is however also possible to charge the air guidance profiles 32, 33 electrostatically in the sense of the invention—also of course other surfaces bounding the working chamber 12, such as e.g. the side wall surfaces 54 of the side walls 14 facing the working chamber 12.

Of course the shielding panel 22 and/or the back panel 17 could also be electrostatically chargeable by the charging means 30. At the same time it is also conceivable that for example the holders 21 are electrically insulated from the shielding panel 22 and/or the back panel 17, so that the holders 21 and the wall surfaces of the back panel 17 and the shielding panel 22 may have different electrical polarity. At least it is for example possible to provide receptacles fastened to the holders 21, and containing for example powder, with a different electrical polarity than that of the walls bounding the intermediate space 23, namely the facing rear side of the shielding panel 22 and the front of the back panel 17. It is however also possible to have an electrical connection between the holders 21 on the one hand and the surfaces bounding the intermediate space 23 on the other hand.

It is possible to provide for the fan arrangement 26 to generate a substantially constant air flow 27. It is however expedient to have a controller 55, e.g. a microprocessor control, which actuates the fan arrangement 26 and/or the charging means 30, in particular the ionisation device 29, on the basis of parameters such as time factors and/or sensor signals. Provided for example is a sensor 56 which is actuated by the door 24 when the latter adopts its closed position S. The sensor 56 then generates a sensor signal which is received by the controller 55 and signals to the latter that the access opening 19 is closed. Then for example the power output of the fan arrangement 26 is reduced so that it generates a weaker air flow 27. For in this case there is no danger that particles 48 may reach the outside through the access opening 19 and harm an operator who may be standing there.

If however the door 24 is moved upwards, i.e. into the open position O, so that it is positioned as shown in FIG. 2 in the area of the upper shield 57 closing the access opening 19 at the top, then the sensor 56 signals “open position O” to the controller 55. The latter increases the power of the fan arrangement 26 so that a stronger air flow 27 is blown in particular out of the air flow outlets 35 and so that at any rate no particles 48 may reach the outside from the working chamber 12, but instead are blown towards the discharge openings 40.

It is also possible for the controller 55 to switch the ionisation device 29 on and off alternately or also to ionise the air flow 27 with different polarity, in particular changing with time.

The discharge openings 40 are here located in the lower part of the shielding panel 22. In this case the discharge openings 40 are slit-shaped. Naturally, other shapes and/or arrangements of discharge openings are also possible. It is also possible for example to provide the side walls with discharge openings.

It goes without saying that other measures may be taken to enhance safety. For example an air curtain device 58 which generates an air curtain 59 may be provided. The air curtain 59 “seals” the access opening 19. For example the air curtain 59 flows from above towards the bottom surface 20, from where it is deflected towards the discharge openings 40. The air curtain device 58 may have an ionisation device or may be in fluidic connection with an ionisation device.

The air guidance surface 38 and/or the step 39 form air guidance means 60 for directing and guiding the air flow 27.

Provided at the door 24 and/or at one or more wall sides of the extractor apparatus 10 are window openings sealed preferably with transparent material, in particular glass, through which one can look into the working chamber 12 from outside.

Of course it is not necessary for the entire air flow 27 to be ionised. For example in the area of the air flow outlet 28 a branch 61 may be provided, over which a portion 27′ of the air flow 27 may be branched off before ionisation. The branch 61 is for example connected for flow purposes to the air flow outlets 36 at the edge of the bottom surface 20.

In connection with FIGS. 7-10, options for optimised ionisation of an air flow, for example the air flow 27, are explained below:

An ionisation device 70 includes for example a carrier 71 which has an elongated shape. The carrier 71 may be fitted for example at the front of the air guidance profile 33.

The ionisation device 70 is located for example in the step 39. Preferably the ionisation device 70 is stuck on to the air guidance profile 33 or welded or screwed to it or the like. Here it is possible to provide an electrically conductive or an electrically insulating connection between the ionisation device 70 and the air guidance profile 33. An ionisation device according to the invention may however also be an integral part of an air guidance profile.

The carrier 71 includes for example a U-shaped profile 72 bounding an interior 73. The interior 73 extends between side walls 74 and a bottom panel 75 of the profile 72. The side walls 74 form side legs of the profile 72.

The side walls 74 serve as support walls for a wall 76. The wall 76 is here a closed or continuous wall which seals the interior 73 at its top. The wall 76 lies opposite the bottom panel 75.

Provided on the wall 76 are supports 77, on which rests a further wall 78, at a distance from the wall 76. A space 79 is provided between the walls 76 and 78.

The supports 77 are for example block-like.

The wall 76, the supports 77 and the upper wall 78 are advantageously electrically insulating. For example they are made of plastic or provided with a plastic coating. The walls 76, 78 and the supports 77 therefore separate electrically insulated chambers from one another.

Located in these chambers are ionising bodies 80. The ionising bodies 80 have several walls 81, running in a zig-zag or wave shape in cross-section. The walls 81 are for example inclined towards one another in the manner of a roof. For example the angle between 2 adjacent walls 81 is approximately 90°, while smaller or larger angles are easily possible.

From each outer wall 81, a mounting section 82 extends to the side, and is used for fastening the ionising body 80 to a base.

At the front, where a particular air flow flows away from the ionising bodies 80, the walls 81 taper to a point. For example the walls 81 have on their front sides tips 83. By this means, advantageously, good separation of the outflowing air is obtained and also optimal ionisation.

The mounting sections 82 are penetrated by mounting bolts 84, which also enter the wall 76, in these case even penetrate it. Free ends of the mounting bolts 84 are in fact connected electrically to electrical conductors 85, 86, so that an electrical connection is made between in each case one of the ionising bodies 80 and one of the conductors 85 or 86. By this means the ionising bodies 80 may be subjected to the potential of the conductor 85 or 86.

The arrangement is advantageously made so that alternately in each case one ionising body 80 is connected electrically to a conductor 85, and an adjacent ionising body 80 in the row direction R is connected electrically to the other conductor 86.

The conductors 85, 86 are located in the interior 73 and are electrically connected for example to first and second charging means 87, 88.

This electrical connection may be a permanent connection, so that for example the charging means 87, 88 supply the conductors 85, 86 in each case with the adjacent output potential.

It is possible for example for the charging means 87 to supply the conductor 85 and the ionising body connected to the latter with a positive potential, and the charging means 88 to supply the conductor 86 and the ionising body 80 connected to the latter with a negative potential or vice-versa.

It is however also possible to have switching means, for example a changeover switch, located between the charging means 87, 88, so that the conductor 85 is connected alternately to charging means 87 or charging means 88, and analogously the conductor 86 is connected alternately to charging means 88 or charging means 87. Here the arrangement is made so that switching means 89 switch the polarity of the charging means 87, 88 or activate a reversal of polarity, so that the charging means 87, 88 alternately provide the conductors 85, 86 with positive or negative electrical potential.

Shown in FIG. 10 is an ionisation device 90. Where components of the ionisation device 90 correspond to those of the ionisation device 70, they are not explained in detail and are given the same reference numbers.

In contrast to the ionisation device 70, however, individual ionising bodies 91 protrude from the conductors 85, 86 with a clearance 79. Here the arrangement is expediently such that an ionising body 91 connected to the conductor 85 and an ionising body 91 connected to the conductor 86 are arranged alternately in a row direction R in which the ionisation devices 70, 90 extend. Consequently the air flow 27 flows relative to the row direction R on one occasion past an ionising body 91 with a first potential and on another occasion past an ionising body 91 with a second potential.

The ionising bodies 91 have a support section 92, which is connected to one of the conductors 85 or 86.

Protruding from each support section 92 is a spike 93. A tip 94 of the spike 93 is oriented in the discharge direction of the air flow 27.

The air flow 27 therefore flows out through the air flow outlets 35 and then past one of the ionising bodies 80 or 91 where it is electrically charged, i.e. ionised.

Advantageously the arrangement is such that the air flow 27 is electrically neutral averaged over space and/or time, when it flows away from the ionisation device 70 or 90.

The ionising bodies 80, 91 are made for example of sheet metal, in particular electrode plate. At any rate the ionising bodies 80, 91 are electrically conductive.

The ionising bodies 80, 91 do not protrude from the walls 76 and/or 78, so that the latter house the ionising bodies 80, 91 protectively.

It goes without saying that e.g. a grid may also be provided for ionisation of an air flow. In FIG. 3 for example an electrically chargeable grid 100 is provided at an air flow outlet 35.

The ionisation devices 70 and/or 90 are expediently in the form of charging modules 95 or 96, which may be retrofitted to a suitably prepared extractor apparatus. Provided for example on the extractor apparatus 10 is a module seating 97, e.g. a module shaft, shown schematically in FIG. 2, into which the charging modules 95 or 96 may be plugged. The module shaft 97 is provided expediently in the area of an air outlet for the air flow 27, e.g. at the air flow outlets 35 or in front of the latter, but may also be provided in the interior of the housing 11.

It is also possible for the charging modules 95 or 96 to form or include the air flow outlets 35. It is also expedient if a module seating is mounted in front of an air flow outlet. For example a module seating 98 may be provided in front of the air flow outlets 35 (FIG. 9), e.g. by suitable design of a section 99 of the air guidance profile 33.

An ionisation device, e.g. a charging module 101 (FIGS. 3, 4), may also be provided at lower and/or side air outlets, e.g. on or in the air guidance profile 33 and/or 32. Here it is advantageous to provide a module seating, e.g. a socket or a shaft, for the charging or ionising module.

1. An extractor apparatus with a working area and with a fan arrangement for generating an air flow or an inlet opening for an air flow for the removal of gases and/or particles from the working area and with at least one surface bordering the working area and further comprising charging means for ionising the air flow and/or for electrostatic charging of at least one surface.

2. An extractor apparatus according to claim 1, wherein the electrostatically chargeable surface or surfaces bounding the working area include(s) at least one side wall surface and/or a bottom surface provided for the placing of objects and/or an inner surface or outer surface of a support element or a air guidance profile.

3. An extractor apparatus according to claim 1, wherein the surface or surfaces has or have at least two zones, electrically insulated from one another, chargeable by the charging means with different electrical polarity.

4. An extractor apparatus according to claim 3, wherein the zone or zones include at least one working zone and at least one boundary zone encompassing the working zone.

5. An extractor apparatus according to claim 1, further comprising air guidance means to direct the air flow or part of the air flow along the surface or surfaces.

6. An extractor apparatus according to claim 1, wherein the working area is bounded at least partly by walls and/or is provided in the interior of a working chamber and/or a housing of the extractor apparatus and/or has a working surface.

7. An extractor apparatus according to claim 6, wherein the working chamber is accessible through an access opening, wherein the access opening may be closed by a door and/or wherein an air curtain device to generate an air curtain is provided at the access opening.

8. An extractor apparatus according to claim 1, wherein the working area is vented through at least one vent hole.

9. apparatus according to claim 1, wherein the charging means have an ionisation device provided at an air flow outlet of the fan arrangement.

10. An extractor apparatus according to claim 1, wherein the charging means are designed to ionise the air flow and/or the surface or surfaces for the purpose of neutralising the air flow and/or the one or more surfaces.

11. An extractor apparatus according to claim 1, further comprising air guidance means for directing the air flow towards at least one surface bounding the working area, for electrostatic charging or discharging.

12. An extractor apparatus according to claim 1 wherein the charging means are designed with varying polarity for ionising the air flow.

13. An extractor apparatus according to claim 1, further comprising switching means for applying an alternately polarised electrical voltage to a surface or to an ionising body for ionising the air flow and/or a surface of the working area.

14. An extractor apparatus according to claim 1, wherein the electrical charging of the air flow ionised by the alternating polarised electrical voltage or the electrically charged surface is approximately zero on a time or spatial average.

15. An extractor apparatus according to claim 1, further comprising a ducting arrangement for distribution of the air flow in the working area and/or to receive the air flow from the working area.

16. An extractor apparatus according to claim 15, wherein the ducting arrangement includes air guidance profiles and/or support elements of a housing encompassing the working area and/or a door for sealing the working area, wherein the air guidance profiles or the support elements have air guidance ducts and/or air flow outlets for the air flow.

17. An extractor apparatus according to claim 16, wherein the air guidance profiles or the support elements have an electrically conductive connection with one another and/or are so interconnected that air guidance ducts inside the connected air guidance profiles or support elements communicate with or are fluidically connected to one another.

18. An extractor apparatus according to claim 1, wherein the charging means have at least one ionising body for ionising the air flow.

19. An extractor apparatus according to claim 18, wherein the ionising body or bodies is or are provided at an air duct or an air flow outlet of an air guidance profile and/or the ionising body or bodies form(s) or include(s) an air guidance surface and/or at least one restrictor and/or at least one discharge nozzle for the air flow.

20. An extractor apparatus according to claim 18, wherein the ionising body or bodies include at least one grid and/or at least one air guidance plate and/or at least one needle point profile and/or at least one wire running at right-angles to the flow direction of the air flow.

21. An extractor apparatus according to claim 18, wherein the ionising body or bodies is or are wave-shaped or zig-zag at right-angles to a flow direction of the air flow and/or that the ionising body or bodies tapers or taper in a discharge direction of the air flow.

22. An extractor apparatus according to claim 18, wherein at least two ionising bodies are arranged next to one another in a row arrangement.

23. An extractor apparatus according to claim 22, wherein the two or more ionising bodies are electrically insulated from one another.

24. An extractor apparatus according to claim 22, further comprising a row arrangement of at least two ionising bodies connected by an electrical conductor, between which is arranged an electrically insulated further ionising body.

25. An extractor apparatus according to claim 1, further comprising at least one first air flow outlet for a first part of the air flow which may be or is ionised or electrically neutralised by the charging means and at least one second air flow outlet for a second part of the air flow which is not capable of ionisation or is not ionised or not electrically neutralised.

26. An extractor apparatus according to claim 1, further comprising a controller for setting an operating mode of the fan arrangement and/or the charging means, depending on a sensor signal and/or a time condition.

27. An extractor apparatus according to claim 1, wherein the charging means include or form at least one charging module for ionising the air flow and/or for electrostatic charging of the surface or surfaces, and wherein on a housing of the extractor apparatus there is at least one module seating fluidically connected to an air duct and/or provided at an air outlet and/or provided on an air guidance profile, to accommodate the charging module or modules.

28. A charging module for an extractor apparatus according to claim 27, wherein the charging module forms the charging means for ionising the air flow and/or for electrostatic charging of the surface or surfaces of at least one charging module, and may be mounted in a module seating for accommodating the charging module or modules provided on a housing of the extractor apparatus.

29. A charging module according to claim 28, further comprising an air inlet and/or an air outlet for the air flow and/or electrical contacts for electrical connection to the surface or surfaces.
